(19) United States
(12) Patent Application Publication
(10) Pub. No.: US 2025/0249815 A1
(43) Pub. Date: Aug. 7, 2025

(54) CARRIAGES FOR VEHICLE PANEL TRANSPORTATION

(71) Applicant: Rivian IP Holdings, LLC, Irvine, CA (US)

(72) Inventors: Lauren SCHIRLE, Costa Mesa, CA (US); Rajinal Ravneet KUMAR, Irvine, CA (US)

(21) Appl. No.: 18/430,548

(22) Filed: Feb. 1, 2024

(51) Int. Cl. B60P 3/00

(52) U.S. Cl. CPC B60P 3/002

(57) ABSTRACT

The present disclosure relates to carriages and related methods for panel (e.g., windshield) transportation. In one or more embodiments, a carriage includes a base, one or more wheels coupled to the base, and a first support block structure supported at least partially by the base. The first support block structure includes a retention opening. The carriage includes a first bar structure extending relative to the base, an angled bar extending at least partially between the first bar structure and the base, and a second support block structure supported at least partially by the angled bar.

### INTRODUCTION

Replacing large vehicle panels, such as a windshield, can be a difficult task. For example, transporting vehicles to service centers can involve time delays and expenditure of resources. Moreover, it is difficult to transport panels to installation sites without breaking or otherwise damaging the panels.

### SUMMARY

The present disclosure relates to carriages and related methods for panel (e.g., windshield) transportation.

In one or more embodiments, a carriage includes a base, one or more wheels coupled to the base, and a first support block structure supported at least partially by the base. The first support block structure includes a retention opening. The carriage includes a first bar structure extending relative to the base, an angled bar extending at least partially between the first bar structure and the base, and a second support block structure supported at least partially by the angled bar.

In one or more embodiments, a carriage includes a base and a first support block structure supported at least partially by the base. The first support block structure includes a retention opening. The carriage includes a first bar structure extending relative to the base, a second bar structure extending relative to the base, and a third bar structure extending relative to the base and spaced from the second bar structure across at least part of the base. The carriage includes a crossbar configured for removable coupling to at least one of the second bar structure or the third bar structure.

In one or more embodiments, a method of panel transportation includes positioning a panel on a carriage and coupling a crossbar to the carriage on a first side of the panel. The method includes abutting an adjustable block structure against the first side of the panel, and positioning the carriage in a vehicle.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting in scope, and may admit to other equally effective embodiments.

FIG. 1 is a schematic perspective view of a vehicle, according to one or more embodiments.

FIG. 2 is a schematic perspective view of a carriage, according to one or more embodiments.

FIG. 3 is a schematic front view of the carriage shown in FIG. 2, according to one or more embodiments.

FIG. 4 is a schematic side view of the carriage shown in FIG. 2, according to one or more embodiments.

FIG. 5 is a schematic enlarged view of the second bar structure and the first fastener shown in FIG. 2, according to one or more embodiments.

FIG. 6 is a schematic enlarged view of the first support block structure shown in FIG. 2, according to one or more embodiments.

FIG. 7 is a schematic perspective view of a support block structure, according to one or more embodiments.

FIG. 8 is a schematic block diagram view of a method of panel transportation, according to one or more embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure relates to carriages and related methods for panel (e.g., windshield) transportation.

A carriage includes a base, one or more wheels coupled to the base, and a first support block structure supported at least partially by the base. The first support block structure includes a retention opening that receives an edge of a panel (e.g., a view panel such as a windshield). The carriage includes a first bar structure extending relative to the base, an angled bar extending at least partially between the first bar structure and the base, and a second support block structure supported at least partially by the angled bar. The panel includes a first side and a second side. The second side of the panel abuts against the second support block structure. After the panel is positioned on the carriage, a crossbar is removably coupled to the carriage on the first side of the panel. An adjustable block structure coupled to the crossbar can abut against the first side of the panel such that the panel is retained between the adjustable block structure and the second support block structure while the edge of the panel is retained in the first support block structure.

Among other technical advantages, the carriage helps to ensure that panels (such as windshields) can be reliably transported in vehicles while maintaining a relatively small footprint, enabling panels to be more easily replaced in the field. For example, a panel can be moved into the vehicle on the carriage, and the vehicle can then transport the carriage (and the panel supported thereon) into the field. The carriage further minimizes the risk of panel breakage and/or tipping over of the panel.

The disclosure contemplates that terms used herein such as “couples,” “coupling,” “couple,” and “coupled” may include but are not limited to welding, fusing, melting together, embedding, bonding, interference fitting, and/or fastening such as by using bolts, threaded connections, rivets, pins, and/or screws. The disclosure contemplates that terms such as “couples,” “coupling,” “couple,” and “coupled” may include but are not limited to integrally forming. The disclosure contemplates that terms such as “couples,” “coupling,” “couple,” and “coupled” may include but are not limited to direct coupling and/or indirect coupling, such as indirect coupling through components such as links, brackets, blocks, and/or frames.

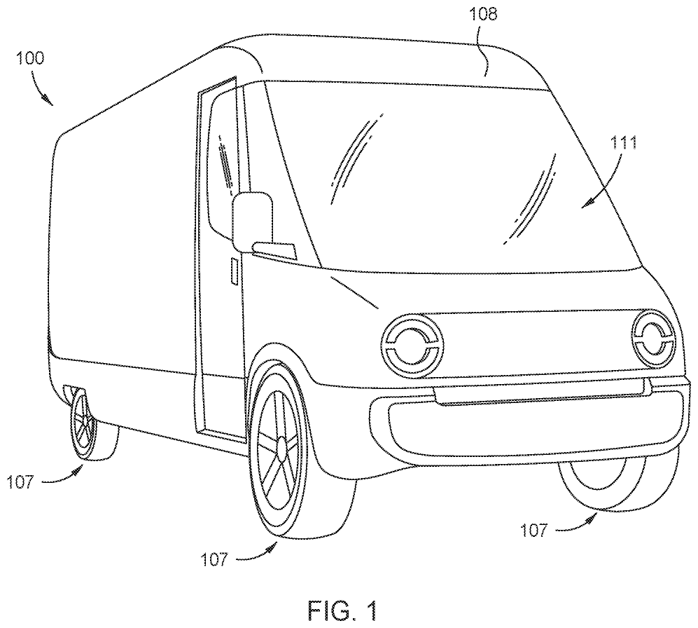

FIG. 1 is a schematic perspective view of a vehicle 100, according to one or more embodiments. The vehicle 100 may include multiple sensors and/or multiple cameras. The vehicle 100 includes one or more wheel modules 107. In the implementation shown in FIG. 1, the vehicle 100 is a van, such as an electric delivery van (EDV). The vehicle includes a panel 111 mounted to a vehicle body 108 of the vehicle 100. In one or more embodiments, the panel 111 is a view panel such as a windshield (e.g., a front windshield). In one or more embodiments, the panel 111 is formed at least partially of glass. The present disclosure contemplates that the subject matter described herein can be used for any other type of vehicle having one or more vehicle panels, such as trucks and/or SUVs.

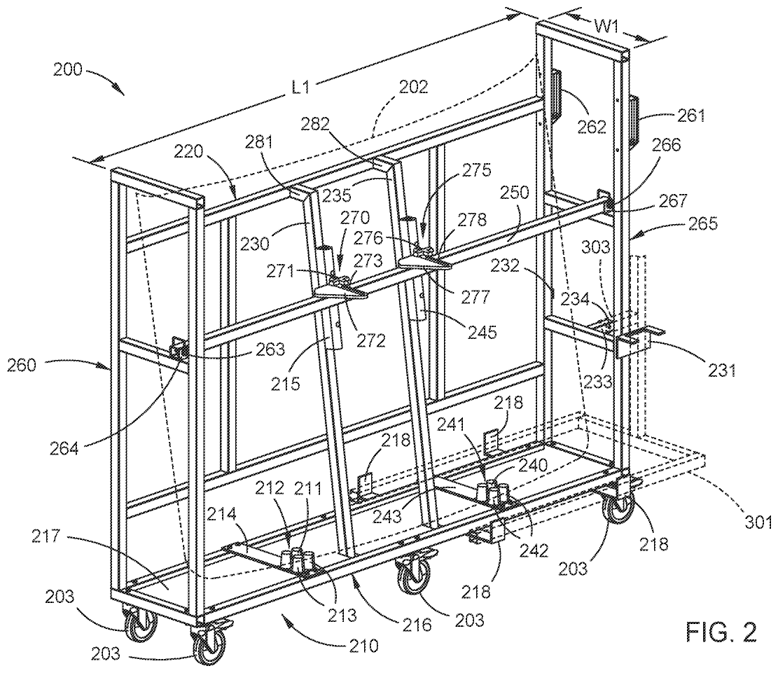

FIG. 2 is a schematic perspective view of a carriage 200, according to one or more embodiments.

The carriage 200 includes a base 210, one or more wheels 203 coupled to the base 210, and a first support block structure 211 supported at least partially by the base 210. The first support block structure 211 includes a retention opening 212. The carriage 200 includes a first bar structure 220 extending relative to the base 210, and an angled bar 230 extending at least partially between the first bar structure 220 and the base 210. The carriage 200 includes a second support block structure 215 supported at least partially by the angled bar 230. In one or more embodiments, the carriage 200 includes a third support block structure 240 supported at least partially by the base 210, a second angled bar 235 extending at least partially between the first bar structure 220 and the base 210, and a fourth support block structure 245 supported at least partially by the second angled bar 235. In one or more embodiments, the first and fourth support block structures 215, 245 respectively include a hollow tube coupled (e.g., fastened) to the respective first angled bar 230 and second angled bar 235. A first connector bar 281 is coupled between the angled bar 230 and the first bar structure 220, and a second connector bar 282 is coupled between the second angled bar 235 and the first bar structure 220. In one or more embodiments, the hollow tube is a D-shaped tube. The third support block structure 240 includes a second retention opening 241. In one or more embodiments, first support block structure 211 and the third support block structure 240 respectively include a plurality of support blocks 213, 242 defining the respective retention opening 212, 241 therebetween. In one or more embodiments, the plurality of support blocks 213, 242 include columns, such as conical columns or frustoconical columns. Other shapes are contemplated for the plurality of support blocks 213, 242. The plurality of support blocks 213, 242 are coupled (e.g., inserted into) a respective plate 214, 243 coupled (e.g., fastened) to the base 210.

The carriage 200 includes a crossbar 250. In one or more embodiments, the crossbar 250 is oriented parallel to the first bar structure 220. The carriage 200 includes a second bar structure 260 extending relative to the base 210, and a third bar structure 265 extending relative to the base 210 and spaced from the second bar structure 260 across at least part of the base 210. The crossbar 250 is configured for removably coupling to at least one of the second bar structure 260 or the third bar structure 265. In one or more embodiments, the crossbar 250 is configured for removably coupling to both of the second bar structure 260 and the third bar structure 265. In one or more embodiments, a first fastener 263 (e.g., a pin, such as a clevis pin) extends through one or more flanges 264 of the second bar structure 260 and the crossbar 250 to removably couple the crossbar 250 to the second bar structure 260. In one or more embodiments, a second fastener 266 (e.g., a pin, such as a clevis pin) extends through one or more flanges 267 of the third bar structure 265 and the crossbar 250 to removably couple the crossbar 250 to the third bar structure 265. A first handle 261 and a second handle 262 are coupled to the third bar structure 265. The handles 261, 262 can be used to move (e.g., push, pull and/or pivot) the carriage 200 by rolling the wheels 203.

The carriage 200 is configured to support and transport a replacement panel 202. In one or more embodiments, the replacement panel 202 is a view panel such as a vehicle windshield (e.g., a front windshield). In one or more embodiments, the replacement panel 202 is formed at least partially of glass. The replacement panel 202 can replace, for example, the panel 111 shown in FIG. 1. The carriage 200 includes a first adjustable block structure 270 coupled to the crossbar 250, and a second adjustable block structure 275 coupled to the crossbar 250. The first and second adjustable block structures 270, 275 respectively include an adjustable block 272, 277, a knob 271, 276, and a guide channel 273, 278 formed in the adjustable block 272, 277. The guide channel 273, 278 respectively defines a track for the adjustable block 272, 277. In one or more embodiments, the respective guide channel 273, 278 includes an aperture formed through the adjustable block 272, 277. In one or more embodiments, the respective adjustable block 272, 277 includes a plate having an irregular shape, such as an irregular triangle shape.

Using the guide channel 273, 278, the respective adjustable block 272, 277 can slide relative to the knob 271, 276 to abut against the replacement panel 202 such that the replacement panel 202 is retained between the adjustable blocks 272, 277 and the first and fourth support block structures 215, 245. The knob 271, 276 extends at least partially through the guide channel 273, 278 of the adjustable block structure 270, 275 to lock and unlock the adjustable block structure 270, 275. The knobs 271, 276 can be turned to tighten the knobs 271, 276 to lock the adjustable blocks 272, 277 in place relative to the knobs 271, 276 and the crossbar 250. The knobs 271, 276 can then be turned to loosen the knobs 271, 276 to unlock the adjustable blocks 272, 277 such that the adjustable blocks 272, 277 can be moved relative to the knobs 271, 276 and the crossbar 250.

In one or more embodiments, the base 210 includes a base bar structure 216. In one or more embodiments, one or more base panels 217 at least partially fill in one or more gaps of the base bar structure 216. At least part of the first support block structure 211 (such as the support blocks 213) and at least part of the second support block structure 215 (such as the hollow tube) have a lower hardness than the base 210 (such as the base bar structure 216 and/or the one or more base panels 217). At least part of the third support block structure 240 (such as the support blocks 242) and at least part of the fourth support block structure 245 (such as the hollow tube) have a lower hardness than the base 210 (such as the base bar structure 216 and/or the one or more base panels 217). In one or more embodiments, one or more of the at least part of the first support block structure 211 (such as the support blocks 213), the at least part of the second support block structure 215 (such as the hollow tube), the at least part of the third support block structure 240 (such as the support blocks 242), and/or the at least part of the fourth support block structure 245 (such as the hollow tube) have a lower hardness than the base 210 (such as the base bar structure 216 and/or the one or more base panels 217) are formed of a first polymeric material. In one or more embodiments, the first polymeric material includes an elastomeric material, such as rubber (for example, an extruded rubber or a molded rubber). In one or more embodiments, the base bar structure 216 is formed of a metal. In one or more embodiments, the one or more base panels 217 are formed of a second polymeric material (such as a plastic, for example polycarbonate) having a higher hardness than the first polymeric material. The present disclosure contemplates that tools (such as drills and/or wrenches) and/or equipment can be supported on the one or more base panels 217 during transportation.

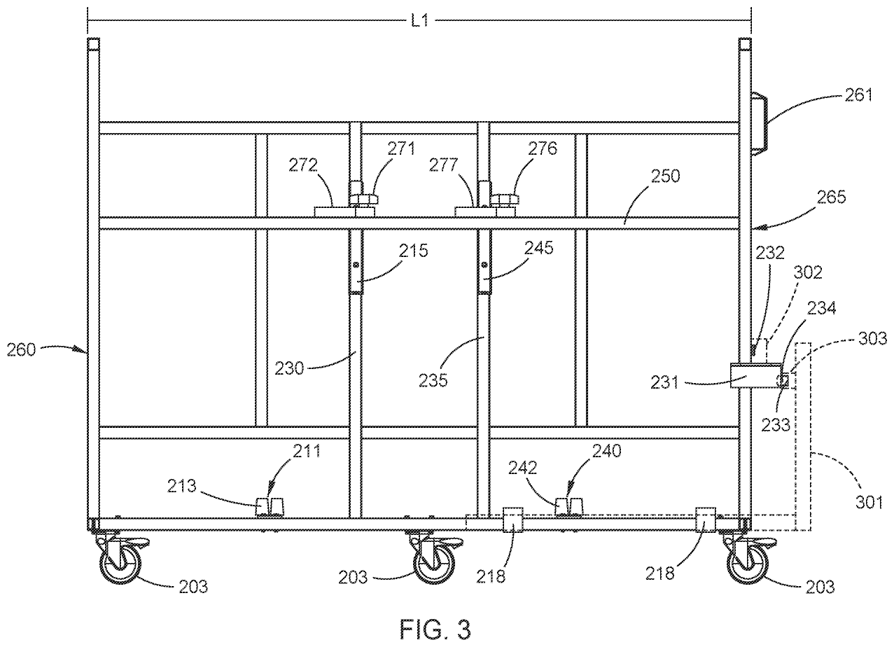

In one or more embodiments, the carriage 200 includes a set of brackets 218 (four brackets 218 are shown in FIG. 2) extending outwardly relative to the base 210. The brackets 218 support a positioning apparatus 301 (described further in relation to FIG. 3). The carriage 200 has a width W1 less than 36 inches, such as less than 30 inches, for example less than 20 inches. The carriage 200 has a length LI less than 90 inches, such as less than 85 inches.

FIG. 3 is a schematic front view of the carriage 200 shown in FIG. 2, according to one or more embodiments.

The first support block structure 211 and the angled bar 230 are positioned between the second bar structure 260 and the third bar structure 265. In one or more embodiments, the third support block structure 240 and the second angled bar 235 are positioned between the second bar structure 260 and the third bar structure 265.

The positioning apparatus 301 is supported by the brackets 218 of the carriage 200 such that the positioning apparatus 301 can be transported by the carriage 200, along with the replacement panel 202 (the replacement panel 202 is not shown in FIG. 3 for visual clarity purposes). The carriage 200 includes an upper bracket 231 on which an arm 302 can be supported, and a locating tab 232 spaced from the upper bracket 231. The arm 302 can slide over the locating tab 232 to help ensure that the arm 302 is aligned in position on the upper bracket 231 for transportation. The locating tab 232 can be part of a bracket. The carriage 200 includes an extension 233 (such as a bar) extending outwardly relative to the third bar structure 265. The extension 233 includes one or more openings 234. The opening(s) 234 of the extension 233 can be aligned with one or more openings formed in one more flanges 303 of the positioning apparatus 301. One or more fasteners (e.g., a pin, such as a clevis pin) can be disposed into the opening(s) of the flange(s) 303 and the opening(s) 234 of the extension 233 to retain the positioning apparatus 301 on the carriage 200 during transportation. After the carriage 200 is transported to an installation site, the one or more fasteners can be removed from the extension 233 and the flange(s) 303 such that the positioning apparatus 301 can be taken off the brackets 218. The arm 302 can then be assembled with the positioning apparatus 301. The crossbar 250 can then be decoupled from the second bar structure 260 and/or the third bar structure 265, and the arm 302 can be used to lift the replacement panel 202 off of the carriage 200 and onto a vehicle.

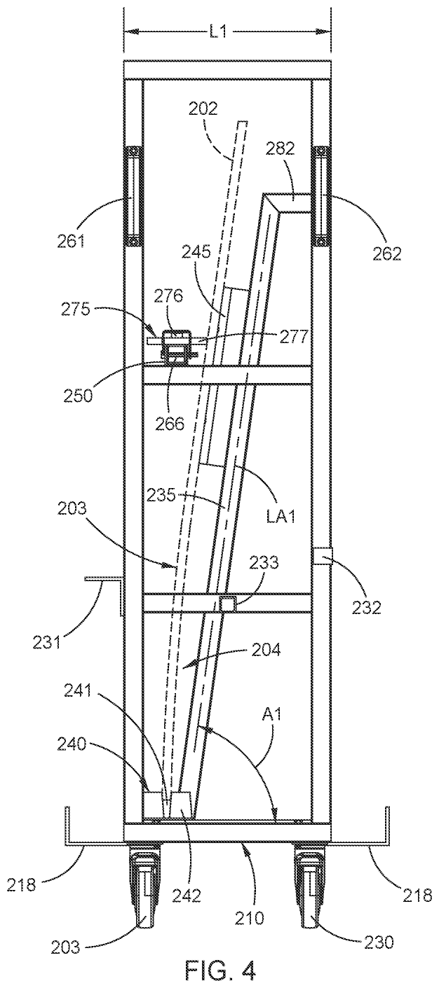

FIG. 4 is a schematic side view of the carriage 200 shown in FIG. 2, according to one or more embodiments.

The angled bar 230 and the second angled bar 235 are oriented at an oblique angle A1 relative to the base 210. In one or more embodiments, the oblique angle A1 is less than 90 degrees and greater than 45 degrees. The oblique angle A1 is defined between an upper surface of the base 210 and a longitudinal axis LAI of the respective angled bar 230 or second angled bar 235. When the adjustable blocks 272, 277 are movable relative to the crossbar 250, planar faces of the adjustable blocks 272, 277 are operable to abut against a first side 205 of the replacement panel 202 to restrain movement of the replacement panel 202 when the replacement panel 202 is supported at least partially by the first support block structure 211 and the second support block structure 215, and/or at least partially by the third support block structure 240 and the fourth support block structure 245. The second support block structure 215 and/or the fourth support block structure 245 support a second side 204 of the replacement panel 202. The crossbar 250 is coupled to the carriage 200 on the first side 205 of the replacement panel 202.

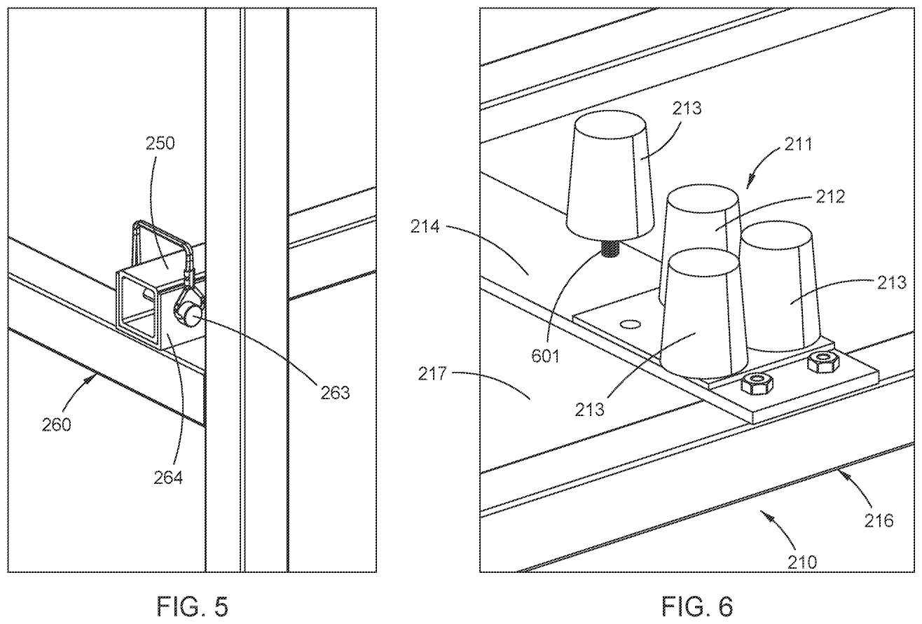

FIG. 5 is a schematic enlarged view of the second bar structure 260 and the first fastener 263 shown in FIG. 2, according to one or more embodiments. In one or more embodiments, the one or more flanges 264, 267 are respectively part of a bracket, such as a U-shaped bracket.

FIG. 6 is a schematic enlarged view of the first support block structure 211 shown in FIG. 2, according to one or more embodiments.

One of the support blocks 213 is shown as exploded away from the plate 214 for illustrative purposes. The support blocks 213, 242 respectively include a fastener 601 (such as a threaded stud) inserted into the support block 213, 242. In one or more embodiments, the support block 213, 242 is molded about a first section (such as a threaded section or a non-threaded section) of the fastener 601. A second section (such as a threaded section) of the fastener 601 extending outside of the support block 213, 242 fastener 601 is fastened (e.g., threaded into) the plate 214 to mount the support block 213, 242 to the plate 214.

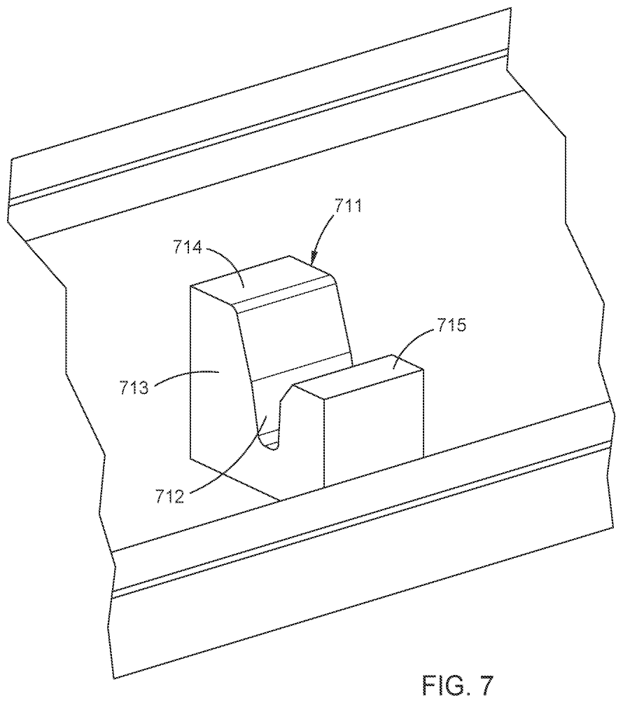

FIG. 7 is a schematic perspective view of a support block structure 711, according to one or more embodiments.

The support block structure 711 includes a single block 713 having a retention opening 712 (e.g., a recess) formed therein. The retention opening 712 is between a pair of ridges 714, 715 of the block 713. The present disclosure contemplates that the support block structure 711 can be used in place of and/or in addition to the first support block structure 211 and the third support block structure 240 shown in FIG. 2.

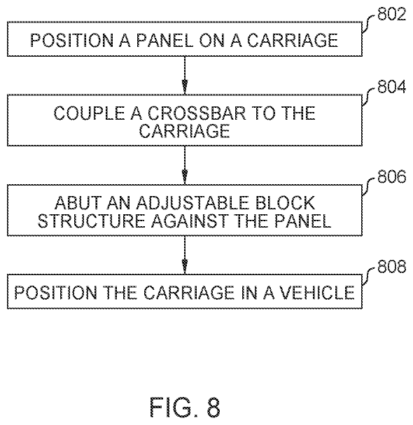

FIG. 8 is a schematic block diagram view of a method 800 of panel transportation, according to one or more embodiments.

The description of the method 800 includes reference to reference numerals shown in FIGS. 1-7, and the present disclosure contemplates that subject matter (such as structures and components) other than the subject matter shown in FIGS. 1-7 can be used in relation to the method 800.

Operation 802 of the method 800 includes positioning a panel 202 on a carriage 200. In one or more embodiments, positioning the panel 202 includes positioning an edge of the panel 202 in a retention opening 212 of a first support block structure 211 or 711 supported at least partially by a base 210 of the carriage 200, and abutting a second side 204 of the panel 202 against a second support block structure 215 supported at least partially by a bar structure 220 extending relative to the base 210. In one or more embodiments, positioning the panel 202 also includes positioning the edge of the panel 202 in a second retention opening 241 of a third support block structure 240 or 711 supported at least partially by the base 210 of the carriage 200, and abutting the second side 204 of the panel 202 against a fourth support block structure 245 supported at least partially by the bar structure 220 extending relative to the base 210.

Operation 804 includes coupling a crossbar 250 to the carriage 200 on a first side 205 of the panel 202.

Operation 806 includes abutting an adjustable block structure 270 against the first side 205 of the panel 202. In one or more embodiments, the adjustable block structure 270 is coupled to the crossbar 250.

The positioning apparatus 301 can be positioned on the carriage 200.

Operation 808 includes positioning the carriage 300 in a vehicle, such as a van.

Benefits of the present disclosure include easy, quick, and reliable replacement of vehicle panels (such as windshields); mobile replacement of vehicle panels; reliable transportation of replacement panels to installation sites with reduced or eliminated chances of panel damage; small carriage footprints; and carriages that support equipment and tools.

As an example, the crossbar 250 and the oblique angle A1 facilitate retaining the replacement panel 202 in a manner that reduces or eliminates tipping over of the carriage 200 while the replacement panel 202 is transported. As another example, the carriage 200 enables such benefits while having a relatively small footprint.

It is contemplated that one or more aspects disclosed herein may be combined. As an example, one or more aspects, features, components, operations and/or properties of the carriage 200, the first support block structure 211, the third support block structure 240, the support block structure 711, the positioning apparatus 301, and/or the method 800 may be combined. Moreover, it is contemplated that one or more aspects disclosed herein may include some or all of the aforementioned benefits.

While the foregoing is directed to embodiments of the present disclosure, other and further embodiments of the disclosure may be devised without departing from the basic scope thereof, and the scope thereof is determined by the claims that follow.

What is claimed is:

1. A carriage, comprising:
a base;
one or more wheels coupled to the base;
a first support block structure supported at least partially by the base, the first support block structure comprising a retention opening;
a first bar structure extending relative to the base;
an angled bar extending at least partially between the first bar structure and the base; and
a second support block structure supported at least partially by the angled bar.

2. The carriage of claim 1, wherein the angled bar is oriented at an oblique angle relative to the base.

3. The carriage of claim 2, wherein the oblique angle is less than 90 degrees and greater than 45 degrees.

4. The carriage of claim 1, further comprising a crossbar oriented parallel to the first bar structure.

5. The carriage of claim 4, further comprising an adjustable block structure coupled to the crossbar and operable to abut against a vehicle windshield to restrain movement of the vehicle windshield when the vehicle windshield is supported at least partially by the first support block structure and the second support block structure.

6. The carriage of claim 4, further comprising:
a second bar structure extending relative to the base; and
a third bar structure extending relative to the base and spaced from the second bar structure across at least part of the base.

7. The carriage of claim 6, wherein the crossbar is removably coupled to at least one of the second bar structure or the third bar structure.

8. The carriage of claim 6, wherein the first support block structure and the angled bar are positioned between the second bar structure and the third bar structure.

9. The carriage of claim 1, further comprising a set of brackets extending outwardly relative to the base.

10. The carriage of claim 1, wherein at least part of the first support block structure and at least part of the second support block structure have a lower hardness than the base.

11. A carriage, comprising:
a base;
a first support block structure supported at least partially by the base, the first support block structure comprising a retention opening;
a first bar structure extending relative to the base;
a second bar structure extending relative to the base;
a third bar structure extending relative to the base and spaced from the second bar structure across at least part of the base; and
a crossbar configured for removable coupling to at least one of the second bar structure or the third bar structure.

12. The carriage of claim 11, further comprising an adjustable block structure coupled to the crossbar.

13. The carriage of claim 12, wherein the adjustable block structure comprises a guide channel defining a track.

14. The carriage of claim 13, further comprising a knob extending at least partially through the guide channel of the adjustable block structure to lock and unlock the adjustable block structure.

15. The carriage of claim 12, wherein the adjustable block structure includes a plate having an irregular shape.

16. The carriage of claim 12, wherein at least part of the first support block structure and at least part of the adjustable block structure have a lower hardness than the base.

17. The carriage of claim 11, further comprising:
an angled bar extending at least partially between the first bar structure and the base; and
a second support block structure supported at least partially by the angled bar.

18. A method of panel transportation, comprising:
positioning a panel on a carriage;
coupling a crossbar to the carriage on a first side of the panel;
abutting an adjustable block structure against the first side of the panel; and
positioning the carriage in a vehicle.

19. The method of claim 18, wherein the positioning the panel comprises:
positioning an edge of the panel in a retention opening of a first support block structure supported at least partially by a base of the carriage; and
abutting a second side of the panel against a second support block structure supported at least partially by a bar structure extending relative to the base.

20. The method of claim 19, wherein the adjustable block structure is coupled to the crossbar.
